(19) United States
(12) Patent Application Publication
(10) Pub. No.: US 2012/0055790 A1
(43) Pub. Date: Mar. 8, 2012

(54) Gas Sensor Assembly with Interior Heat Dissipation, Sealing, and Support Plug

(76) Inventors: Robert L. Newman, Edwardsburg, MI (US); Terry R. Bloom, Middlebury, IN (US); Danny L. Koester, Elkhart, IN (US)

(21) Appl. No.: 13/223,849

(22) Filed: Sep. 1, 2011

Related U.S. Application Data
(60) Provisional application No. 61/379,889, filed on Sep. 3, 2010.

(51) Int. Cl. G01N 27/30

(52) U.S. Cl. 204/431

(57) ABSTRACT

A gas sensor assembly including a substrate located in a housing. The substrate includes a high temperature gas sensor end and a lower temperature electronics end. A heat transfer, sealing, and support plug is mounted in the housing to the substrate. The plug seals the sensor end from the electronics end and transfers the heat generated at the high temperature sensor end successively through the substrate, the thermally conductive plug, the housing, and into the outside air. In one embodiment, the housing includes a collar which surrounds a portion of the substrate and is coupled to and supported on one end of the plug and a jacket which surrounds the electronics end of the substrate and includes a neck coupled to and supported on an opposite end of the plug.

### CROSS-REFERENCE TO RELATED APPLICATIONS

This application claims the benefit of the filing date and disclosure of U.S. Provisional Patent Application Ser. No. 61/379,889 filed on Sep. 3, 2010, the entire disclosure of which is explicitly incorporated herein by reference as are all references cited therein.

### FIELD OF THE INVENTION

The present invention is directed to a gas sensor assembly and, more specifically, to an assembly for sensing the content of the gases of a vehicle exhaust system.

### BACKGROUND OF THE INVENTION

Various devices are known for detecting the presence of combustible gases such as, for example, hydrocarbons and nitrogen oxides, in the exhaust systems of vehicle engines. The gas sensor assembly disclosed in U.S. Pat. No. 5,880,354 to Newman et al. is an example of one such gas sensor assembly.

A common feature of all such gas sensor assemblies is the presence and use of a substrate therein which at one end includes a sensor element for sensing the content of the high temperature exhaust gas and an opposite end which includes the sensor element conditioning circuitry and operates at a much lower temperature than the sensor element.

Given the substantially diverse operating temperature ranges at which the sensor element and conditioning circuitry operate, there continues to be a need for a gas sensor assembly with structure adapted to keep the lower temperature conditioning circuitry end of the substrate isolated and sealed from the high temperature sensor element end of the substrate. This invention addresses this continuing need.

### SUMMARY OF THE INVENTION

The present invention is directed generally to a gas sensor assembly which comprises a housing, a substrate which is located in the housing and including a sensor portion and an electronics portion, and a plug which is located in the housing between the sensor portion and the electronics portion and seals the sensor portion from the electronics portion.

In one embodiment, the substrate includes an elongated intermediate portion between the sensor portion and the electronics portion, the plug surrounds and abuts against an exterior surface of the intermediate portion of the substrate, and the housing surrounds and abuts against an exterior surface of the plug.

The housing includes a collar which surrounds the intermediate portion and is coupled to the plug and also a jacket which surrounds the electronics portion of the substrate and is also coupled to the plug.

In one embodiment, one end of the collar is coupled to one end of the plug and the jacket includes a neck which is coupled to the opposite end of the plug. The collar and the neck of the jacket are spaced from each other on the plug.

Further, in one embodiment, the jacket surrounding the electronics portion of the substrate includes an exterior peripheral surface defining at least one clip and an open end and the gas sensor assembly further comprises a connector including a base extending into the open end of the jacket and a flange which is secured to the clip on the jacket for securing the connector to the jacket.

In another embodiment, a gas sensor assembly comprises a substrate which includes a base having electronics mounted thereon and a beam having at least a sensor mounted thereon; a plug located on the beam of the substrate between the electronics and the sensor; a collar surrounding the beam of the substrate and including one end coupled to the plug; a jacket surrounding the base of the substrate and including a neck at one end coupled to the plug and an opposed open end; and a connector including a base extending into and coupled to the open end of the jacket.

In one embodiment, the plug surrounds and is abutted against an exterior surface of the beam of the substrate.

In one embodiment, the collar includes an end coupled to one end of the plug.

In one embodiment, the collar and the neck of the jacket are spaced from each other on the plug.

In one embodiment, the open end of the jacket includes a clip, and the base of the connector includes a flange which couples to the clip of the jacket.

In yet another embodiment, a gas sensor assembly comprises a housing with a substrate located in the housing. The substrate includes a high temperature gas sensor end and a lower temperature electronics end, and a thermally conductive plug mounted in the housing to the substrate. The plug seals the sensor end of the substrate from the electronics end of the substrate and transfers the heat generated at the high temperature sensor end of the substrate through the substrate, the thermally conductive plug, and the housing.

In one embodiment, the housing includes a collar which surrounds a portion of the substrate and is coupled to and supported on an end of the plug and a jacket which surrounds the electronics end of the substrate and includes a neck coupled to and supported on an opposite end of the plug.

Other advantages and features of the present invention will be more readily apparent from the following detailed description of the preferred embodiment of the invention, the accompanying drawings, and the appended claims.

### BRIEF DESCRIPTION OF THE DRAWINGS

These and other features of the invention can best be understood by the following description of the accompanying drawings in which:

FIG. 1 is an enlarged perspective view of a gas sensor assembly in accordance with the present invention;

FIG. 2 is an enlarged vertical cross-sectional view of the gas sensor assembly shown in FIG. 1; and

FIG. 3 is an enlarged vertical cross-sectional view of the interior heat dissipation, sealing, and support plug of the gas sensor assembly of the present invention.

### DETAILED DESCRIPTION OF THE EMBODIMENT

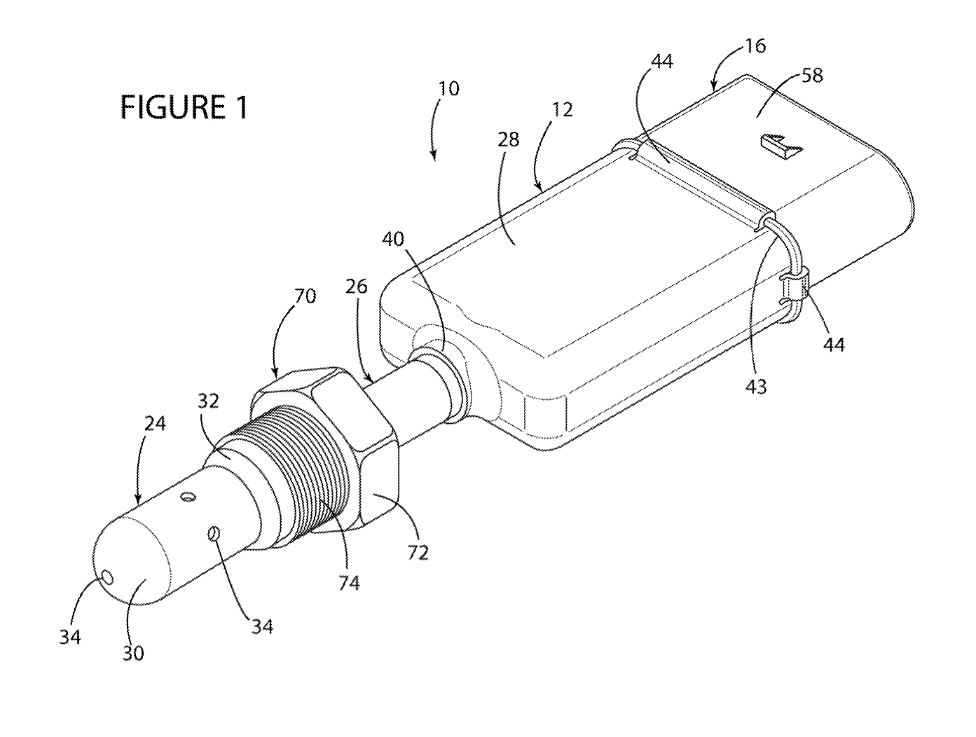

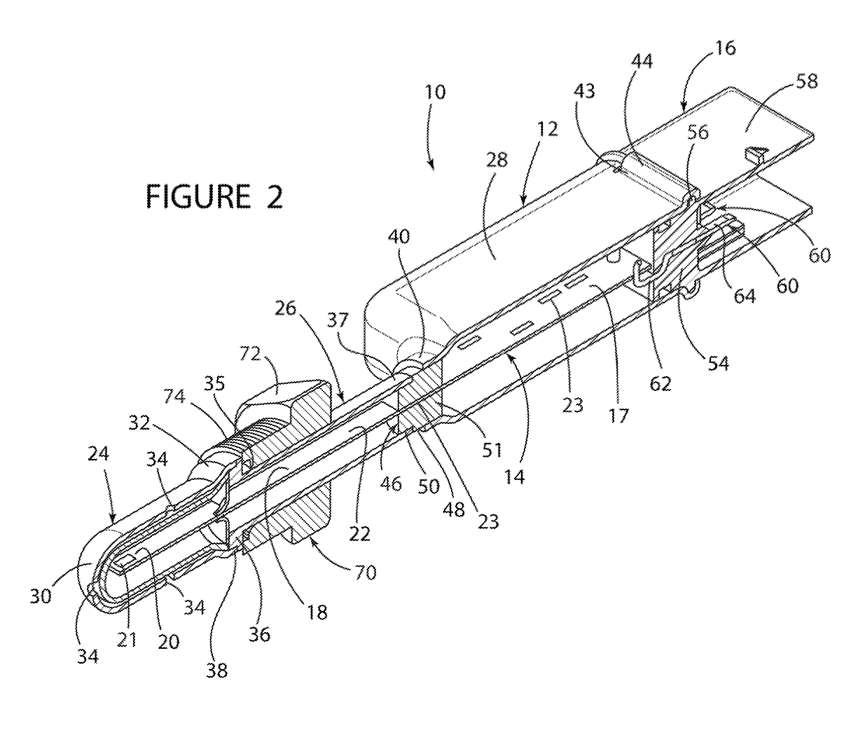

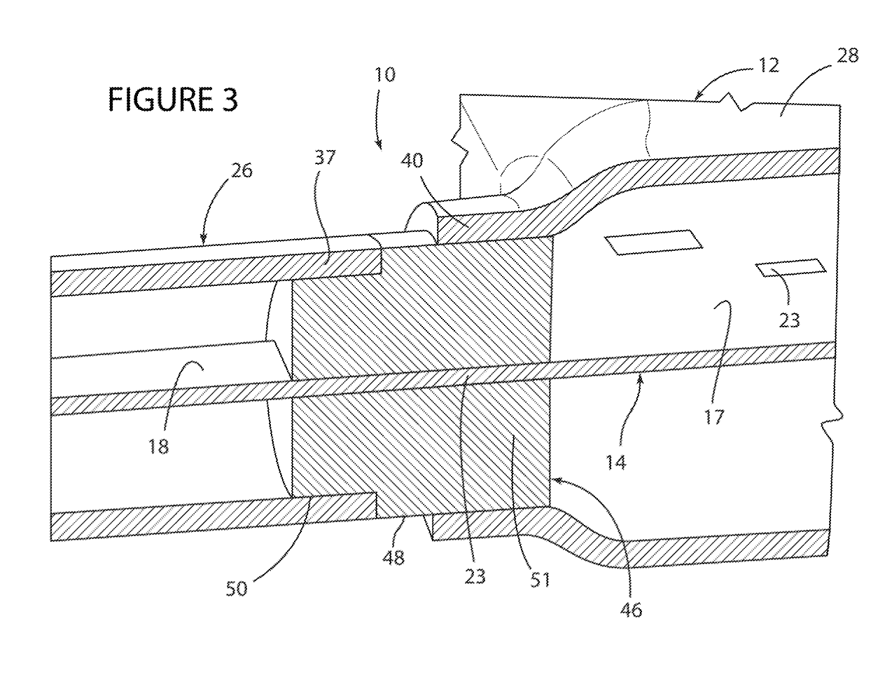

FIGS. 1, 2, and 3 depict one embodiment of a gas sensor assembly 10 in accordance with the present invention which comprises a housing 12 for a gas sensor substrate 14 (FIGS. 2 and 3) and an electrical connector assembly 16 (FIGS. 1 and 2) coupled to one end of the housing 12. The gas sensor assembly 10 is suited for sensing the content of the gases in a vehicle exhaust system including, for example, the presence of hydrocarbon and nitrogen oxides in the gas.

The sensor substrate 14 shown in cross-section in FIGS. 2 and 3 is in the shape of a flat plate which includes a proximal, generally rectangularly-shaped base member or electronics portion 17 and an elongated, generally flat beam member or sensor portion 18 extending unitarily outwardly from one end of the base member 17. The beam member 18, which has a width substantially less than the width of the base member 17, includes a distal sensor end portion 20 (FIG. 2) and an elongated intermediate transition portion 22 (FIGS. 2 and 3) extending unitarily between the distal sensor portion 20 and the base member or electronics portion 17.

Although not shown or described in this application in any detail, it is understood that the substrate 14 and, more specifically, the beam member 18 thereof is made of any suitable dielectric material such as, for example, a ceramic material. Still more specifically, it is understood that at least a sensor element 21 (FIG. 2) and a heater element (not shown) are mounted to one or both of the exterior surfaces of the distal sensor portion 20 of the substrate 14 and further that the electronic conditioning elements and circuitry 23 (FIGS. 2 and 13) adapted to provide the required heater control, sensor output compensation, and communication with the vehicle, are mounted to one or both of the exterior surfaces of the base member 17 of the substrate 14. The sensor element 21 and the heater element (not shown) are coupled to the electronic conditioning elements and circuitry 23 via electrical traces (not shown) which are formed on the substrate 14.

The housing 12 is comprised of three separate components including a generally oval-shaped distal sensor end cap 24 (FIGS. 1 and 2) surrounding and spaced from the distal sensor portion 20 of the substrate 14; a generally cylindrically-shaped and elongate collar or tube 26 surrounding and spaced from the intermediate elongate transition portion 22 of the substrate 14; and a generally rectangularly-shaped case or jacket 28 surrounding and spaced from the base member 17 of the substrate 14. The cap 24, the collar 26, and the jacket 28 are all preferably made of a high strength metallic material such as, for example, steel.

As shown in FIGS. 1 and 2, the cap 24 includes a closed distal end 30 and an open opposed proximal end defined in part by a peripheral and circumferentially extending flange 32. A plurality of exhaust gas entry apertures 34 are defined in and extend through the body of the cap 24. The cap serves the dual purpose of protecting the sensor element 21 on the substrate 14 from the exhaust gas system environment while, at the same time, also providing for entry of the exhaust gas therein through the respective apertures 34 for sensing by the sensor element 21 on the distal sensor portion 20 of the substrate 14.

The collar 26 (FIGS. 1, 2, and 3) is open at opposite ends 35 and 37 (FIGS. 1, 2, and 3). The end 35 thereof includes a circumferentially extending annular flange 36 (FIG. 2) having and defining a circumferentially extending shoulder 38 (FIG. 2).

The jacket 28 (FIGS. 1, 2, and 3) converges at one end into an open neck 40 (FIGS. 1, 2, and 3). The opposite end of the jacket 28 is also open and includes a circumferentially extending peripheral and generally oval-shaped edge 43 (FIGS. 1 and 2) defining a plurality of spaced-apart and generally arcuate open clip fingers 44 (FIGS. 1 and 2).

The gas sensor assembly 10 still further comprises an interior heat dissipation, sealing, and mechanical support plug 46 (FIGS. 2 and 3). The plug 46 is a generally cylindrically-shaped solid block of thermally conductive metallic material such as, for example, steel which includes an exterior circumferentially extending surface 48 (FIGS. 2 and 3) with a shouldered or recessed end 50 and an opposite end 51.

The gas sensor assembly 10 still additionally comprises the connector assembly 16 (FIGS. 1 and 2) which includes a generally solid proximal base 54 (FIG. 2) with a circumferentially extending exterior peripheral flange 56; an open distal neck or shroud 58 (FIGS. 1 and 2) extending outwardly from one end of the base 54; and a plurality of terminals 60 (FIG. 2) extending through the interior of the base 54. Each of the terminals 60 defines one end 62 (FIG. 2) protruding outwardly from one of the side faces of the base 54 into the interior of the jacket 28 of the housing 12, and an opposite end 64 (FIG. 2) protruding outwardly from the opposite side surface of the base 54 into the interior of the neck or shroud 58 of the connector assembly 16.

In accordance with the present invention, and as particularly shown in FIGS. 2 and 3, the plug 46 surrounds and is coupled and secured, as by brazing or the like technique, to a segment 23 of the intermediate transition portion 22 of the beam member 18 of the substrate 14. Stated another way, the segment 23 of the intermediate transition portion 22 of the substrate 14 extends through the center of the block of the plug 46.

The collar 26 and, more specifically, the end 37 thereof, is coupled, as by welding or the like, to the circumferentially extending peripheral shoulder 50 defined on the exterior surface 48 of the plug 46.

The neck 40 of the jacket 28 in turn surrounds and is coupled to, also as by welding or the like, to the end 51 of the plug 46 opposite the shouldered end 50 of the plug 46 which is coupled to the collar 26. The neck 40 of the jacket 28 is spaced on the plug 46 from the end of the collar 26.

The cap 24 and, more specifically, the flange 32 thereof is coupled to the shoulder 38 defined on the flange 36 at the open end 35 of the collar 26 (FIGS. 2 and 3).

The solid base 54 of the connector assembly 16 extends into the open end of the jacket 28 into a relationship adjoining the end of the base member 17 of the substrate 14 and the flange 56 of the base 54 of the connector is received in the clip fingers 44 defined on the peripheral edge 43 of the jacket 28 to secure the connector assembly 16 to the jacket 28 (FIG. 2). The end 62 of the respective terminals 60 are coupled, as by soldering or the like, to the base member 17 of the substrate 14 as shown in FIG. 2 to provide the electrical connection between the gas sensor assembly 10 and the engine control system (not shown).

Additionally, and as shown in FIGS. 1 and 2, the gas sensor assembly 10 still further comprises a mounting nut 70 which surrounds, and rotates relative to, the collar 26. The mounting nut 70 includes a head 72 and a threaded portion 74. The nut 70 is located on the collar 26 aft and abutting against the exterior surface of the flange 36 at the end 35 of the collar 26.

The plug 46 serves several functions. Initially, and inasmuch as the distal end portion 20 of the beam member 18 of the substrate 14 is self-heated to operating temperatures above 500° C. and the base member 17 of the substrate 14 must remain at a substantially lower operating temperature (in the order of about 150° C.) appropriate for the electronic components (not shown) mounted thereon, the plug 46 initially acts as a barrier which prevents the heat generated at the distal end portion 20, and radiating through the intermediate portion 22, from being transferred to the base member 16; and, more specifically, advantageously redirects the thermal path and transfer of the generated heat successively from the intermediate portion 22 of the substrate 14, through the thermally conductive material of the plug 46, into and through the thermally conductive material of the collar 26 surrounding and coupled to the plug 46, and then to the air surrounding the exterior of the collar 26.

The plug 46 also advantageously provides and creates a seal between the electronics (not shown) mounted on the base member 17 of the substrate 14 and the exhaust gases present at the distal end portion 20 of the substrate 14.

The plug 46 and, more specifically, the exterior surface 48 thereof, additionally defines and provides a weldable surface for the collar 26 and the jacket 28 of the housing 12.

Additionally, the mounting and coupling of the substrate 14 directly to the plug 46 and the mounting and support of the collar 26 and the jacket 28 of the housing 12 directly to and on the exterior of the plug 46 allows for the differential thermal expansion of the substrate 14 relative to the collar 26 and the jacket 28, i.e., allows for the expansion and contraction of the collar 26 and the jacket 28 in response to changes in temperature without putting any mechanical stress on the substrate 14.

Numerous variations and modifications of the embodiment described above may be effected without departing from the spirit and scope of the novel features of the invention. It is to be understood that no limitations with respect to the specific gas sensor assembly illustrated herein are intended or should be inferred. It is, of course, intended to cover by the appended claims all such modifications as fall within the scope of the claims.

We claim:

1. A gas sensor assembly comprising:
a housing;
a substrate located in the housing, the substrate including a sensor portion and an electronics portion; and
a plug located in the housing between the sensor portion and the electronics portion for sealing the sensor portion from the electronics portion.

2. The gas sensor assembly of claim 1, wherein the substrate further includes an elongated intermediate portion between the sensor portion and the electronics portion, the plug surrounding and abutting against an exterior surface of the intermediate portion of the substrate and the housing surrounding and abutting against an exterior surface of the plug.

3. The gas sensor assembly of claim 2, wherein the housing includes a collar which surrounds the intermediate portion of the substrate and is coupled to the plug and a jacket which surrounds the electronics portion of the substrate and is also coupled to the plug.

4. The gas sensor assembly of claim 3, wherein the collar includes one end coupled to one end of the plug and the jacket includes a neck coupled to another end of the plug, the one end of the collar being spaced on the plug from the neck of the collar.

5. The gas sensor assembly of claim 1, wherein the housing includes a jacket surrounding the electronics portion of the substrate, the jacket including an exterior peripheral edge defining at least one clip and an open end, the gas sensor assembly further comprising a connector including a base extending into the open end of the jacket and a flange which is secured to the clip on the jacket for securing the connector to the jacket.

6. A gas sensor assembly comprising:
a substrate including a base having electronics mounted thereon and a beam having at least a sensor mounted thereon;
a plug located on the beam of the substrate between the electronics and the sensor;
a collar surrounding the beam of the substrate and including one end coupled to the plug;
a jacket surrounding the base of the substrate and including a neck at one end coupled to the plug and an opposed open end; and
a connector including a base extending into and coupled to the open end of the jacket.

7. The gas sensor assembly of claim 6, wherein the plug surrounds and is abutted against an exterior surface of the beam of the substrate.

8. The gas sensor assembly of claim 7, wherein the collar includes an end coupled to one end of the plug.

9. The gas sensor assembly of claim 8, wherein the collar and the neck of the jacket are spaced from each other on the plug.

10. The gas sensor assembly of claim 6, wherein the open end of the jacket includes a clip, the base of the connector including a flange which couples to the clip of the jacket.

11. A gas sensor assembly comprising:
a housing;
a substrate located in the housing, the substrate including a high temperature gas sensor end and a lower temperature electronics end; and
a thermally conductive plug mounted in the housing to the substrate, the plug sealing the sensor end of the substrate from the electronics end of the substrate and transferring the heat generated at the high temperature sensor end of the substrate through the substrate, the thermally conductive plug, and the housing.

12. The gas sensor assembly of claim 11, wherein the housing includes a collar which surrounds a portion of the substrate and is coupled to and supported on an end of the plug and a jacket which surrounds the electronics end of the substrate and includes a neck coupled to and supported on an opposite end of the plug.
